(19) United States
(12) Patent Application Publication
(10) Pub. No.: US 2024/0428508 A1
(43) Pub. Date: Dec. 26, 2024

(54) DISPLAY METHOD AND DISPLAY DEVICE

(71) Applicant: Lenovo (Beijing) Limited, Beijing (CN)

(72) Inventors: Jie YIN, Beijing (CN); Yinzhu PIAO, Beijing (CN); Cen YAO, Beijing (CN)

(21) Appl. No.: 18/650,899

(22) Filed: Apr. 30, 2024

(30) Foreign Application Priority Data
Jun. 26, 2023 (CN) 202310760042.4

(51) Int. Cl. G06T 15/50; G06T 13/20

(52) U.S. Cl. CPC G06T 15/506; G06T 13/20

(57) ABSTRACT

A display method includes acquiring position information of a mouse; acquiring three-dimensional object display areas of a glasses-free three-dimensional screen; adjusting illumination information within a target area according to the three-dimensional object display areas and the position information, the target area being a preset range area centered on a position corresponding to the position information, and the illumination information including at least one of brightness information, contrast, and shadow sharpness of a three-dimensional object; and displaying the three-dimensional object in the three-dimensional object display areas according to the adjusted illumination information.

### CROSS-REFERENCE TO RELATED APPLICATION

This application claims priority of Chinese Patent Application No. 202310760042.4, filed on Jun. 26, 2023, the entire contents of which are hereby incorporated by reference.

### FIELD OF THE DISCLOSURE

The present disclosure generally relates to the field of human-computer interaction technology and, more particularly, relates to a display method and a display device.

### BACKGROUND

On an electronic device, users can indicate any position on a display system of the electronic device by operating a mouse. The electronic device then performs corresponding operation according to a position indicated by the user and other control instructions. For the user to identify the indicated position, the display system usually displays a cursor at the indicated position.

When the display system is configured to display a three-dimensional scene composed of three-dimensional models of several objects, the cursor is also displayed as a three-dimensional model. A cross-mode phenomenon is prone to occur between the cursor and the objects, that is, there is partial overlap between the three-dimensional model of the cursor and the three-dimensional model of the objects.

### BRIEF SUMMARY OF THE DISCLOSURE

One aspect of the present disclosure provides a display method. The display method includes acquiring position information of a mouse; acquiring three-dimensional object display areas of a glasses-free three-dimensional screen; adjusting illumination information within a target area according to the three-dimensional object display areas and the position information, the target area being a preset range area centered on a position corresponding to the position information, and the illumination information including at least one of brightness information, contrast, and shadow sharpness of a three-dimensional object; and displaying the three-dimensional object in the three-dimensional object display areas according to the adjusted illumination information.

Another aspect of the present disclosure provides a display device. The display device includes one or more processors configured to perform acquiring position information of a mouse; acquiring three-dimensional object display areas of a glasses-free three-dimensional screen; and adjusting illumination information within a target area according to the three-dimensional object display areas and the position information, the target area being a preset range area centered on a position corresponding to the position information, and the illumination information including at least one of brightness information, contrast, and shadow sharpness of a three-dimensional object. The display device further includes a display unit configured for displaying a three-dimensional object in the three-dimensional object display areas according to the adjusted illumination information.

Other aspects of the present disclosure can be understood by a person skilled in the art in light of the description, the claims, and the drawings of the present disclosure.

### BRIEF DESCRIPTION OF THE DRAWINGS

To describe technical solutions in embodiments of the present disclosure more clearly, accompanying drawings required to be used in the embodiments of the present disclosure will be briefly introduced below. Obviously, the accompanying drawings described below are some embodiments of the present disclosure. A person skilled in the art may further derive other drawings from the accompanying drawings without creative efforts.

FIG. 1 illustrates a flow chart of a display method consistent with various embodiments of the present disclosure.

FIG. 2 illustrates a schematic diagram of adjusting illumination information between adjacent three-dimensional object display areas consistent with various embodiments of the present disclosure.

FIG. 3 illustrates a schematic diagram for displaying three-dimensional objects according to adjusted illumination information consistent with various embodiments of the present disclosure.

FIG. 4 illustrates another schematic diagram for displaying a three-dimensional object according to adjusted illumination information consistent with various embodiments of the present disclosure.

FIG. 5 illustrates another schematic diagram for displaying three-dimensional objects according to adjusted illumination information consistent with various embodiments of the present disclosure.

FIG. 6 illustrates a comparison diagram of directly displaying a cursor and adjusting illumination information consistent with various embodiments of the present disclosure.

FIG. 7 illustrates a schematic diagram of a display device consistent with various embodiments of the present disclosure.

### DETAILED DESCRIPTION

Technical solutions in the embodiments of the present disclosure will be clearly and completely described below with reference to accompanying drawings in the embodiments of the present specification. Obviously, the described embodiments are only some of the embodiments of the present specification, but not all of the embodiments. According to the embodiments of the present disclosure, all other embodiments acquired by those skilled in the art without creative efforts fall within the protection scope of the present specification.

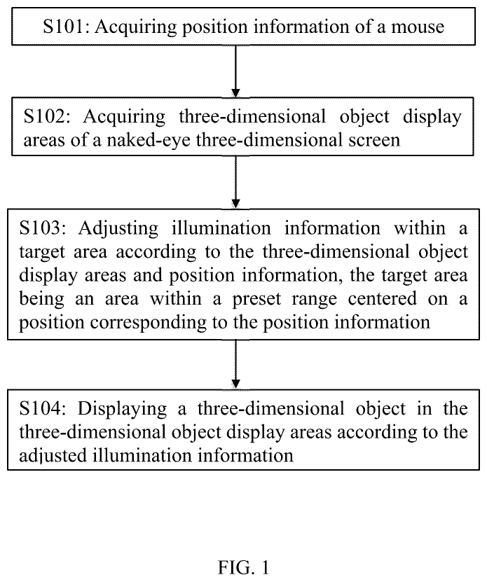

FIG. 1 illustrates a flow chart of a display method consistent with various embodiments of the present disclosure. In one embodiment, the display method can be applied to an electronic device arranged with a glasses-free three-dimensional screen. An execution subject of each step in the embodiment can be considered as a processor of the electronic device. The method may include the following steps.

S101: acquiring position information of a mouse.

The position information of the mouse refers to position information provided by the mouse to indicate a specific position on the glasses-free three-dimensional screen. The position information can be represented by a set of plane coordinate values. For example, the position information of the mouse acquired in S101 may be (20, 30), which represents a point with an abscissa of 20 and an ordinate of 30 on the glasses-free three-dimensional screen. In practical applications, the position information of the mouse can be changed in real time according to user's operations. In S101, the processor of the electronic device can receive displacement data sent by the mouse. The displacement data is used to represent a mouse's moving direction, moving distance, moving speed and other information. The processor can determine the position information of the mouse on the glasses-free three-dimensional screen according to the displacement data of the mouse. Specific methods of determining position information can be referred to mouse-related technologies, which are not repeated herein.

S102: acquiring three-dimensional object display areas of the glasses-free three-dimensional screen.

The three-dimensional object display areas refer to areas configured to display three-dimensional objects on the glasses-free three-dimensional screen, one or more independent three-dimensional object display areas can exist on the glasses-free three-dimensional screen simultaneously. One or more three-dimensional objects can be displayed in one three-dimensional object display area.

On the glasses-free three-dimensional screen, a three-dimensional object can move according to certain rules. For example, a three-dimensional model of a vehicle can move from the left to the right of the screen, and a three-dimensional model of a sphere can move from the top to the bottom of the screen. Accordingly, a three-dimensional object display area can also move with a movement of a three-dimensional object.

The three-dimensional object display areas can also appear or disappear over time. For example, the electronic device can perform three-dimensional rendering on a two-dimensional object originally displayed on the screen and convert the two-dimensional object into a three-dimensional object. Accordingly, an area originally used to display two-dimensional objects becomes a three-dimensional object display area. The electronic device can also cease rendering the originally displayed three-dimensional object, converting the three-dimensional object into a two-dimensional object, and causing the three-dimensional object display areas where the three-dimensional objects are located to disappear.

In S102, the processor can acquire information such as positions, shapes and outlines of the three-dimensional object display areas currently included in the glasses-free three-dimensional screen. According to the information, the processor can determine which pixels on the glasses-free three-dimensional screen are within the three-dimensional object display areas and which pixels are outside the three-dimensional object display areas.

Optionally, acquiring the three-dimensional object display areas may be that the processor reads image data currently displayed on the glasses-free three-dimensional screen, identifies an area where the three-dimensional model is located in the image data, and identifies the three-dimensional object on the glasses-free three-dimensional screen according to the area where the three-dimensional model is located and a mapping relationship between the image data and the glasses-free three-dimensional screen.

S103: adjusting illumination information within a target area according to the three-dimensional object display areas and position information, the target area being an area within a preset range centered on a position corresponding to the position information.

The illumination information includes at least one of brightness information, contrast, and shadow sharpness of the three-dimensional object.

In S103, a determination to adjust the illumination information in the target area can be made according to the positional relationship between the position indicated by the position information and the three-dimensional object display areas. Once the determination to adjust the illumination information is made, any one or more of the above three attributes of the illumination information is adjusted according to a content displayed in the target area.

In one embodiment, the processor can adjust the illumination information in the target area when any of the following conditions are met between the position information and the three-dimensional object display areas.

In a first condition, regardless of whether a target position indicated by the position information is in the three-dimensional object display areas, the illumination information is adjusted within the target area. Under the first condition, when the target position is not in the three-dimensional object display areas, only the brightness information is adjusted within the target area. When the target position remains within the three-dimensional object display areas, the brightness information and the three-dimensional object's brightness information can be adjusted simultaneously within the target area.

In a second condition, if the target position is within the three-dimensional object display areas, the illumination information is adjusted within the target area, if the target position is not in the three-dimensional object display areas, the illumination information is not adjusted within the target area. Under the second condition, if the target position is not in the three-dimensional object display areas, a preset cursor image can be displayed in the target area, or the three-dimensional object of the cursor can be displayed.

In a third condition, if the target position remains within the three-dimensional object display areas, or between adjacent three-dimensional object display areas, the illumination information is adjusted within the target area. If the target position is not within the three-dimensional object display areas and is not between adjacent three-dimensional object display areas. time, the illumination information is not adjusted within the target area and a preset cursor image can be displayed within the target area, or a three-dimensional object of the cursor.

Adjacent three-dimensional object display areas refer to two three-dimensional object display areas whose distance is not greater than a distance threshold. The distance threshold can be set according to actual situations, which are not limited herein.

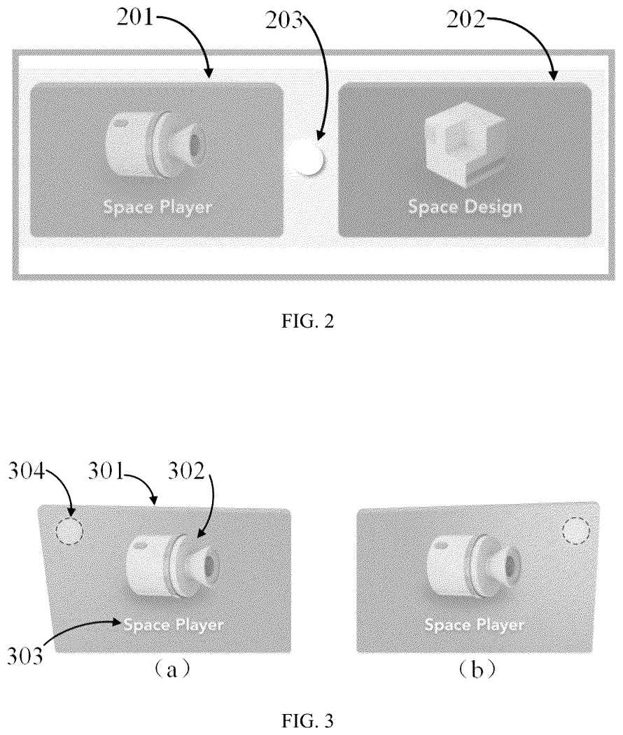

When determining whether to adjust the illumination information according to the third condition, the glasses-free three-dimensional screen may display a three-dimensional object display interface, as shown in FIG. 2. Areas 201 and 202 represent two independent three-dimensional object display areas and the distance therebetween is small. Therefore, areas 201 and 202 can be considered to be two adjacent three-dimensional object display areas.

Area 203 represents a target area. Since the target area is between the adjacent three-dimensional object display areas 201 and 202, the electronic device adjusts the illumination information in the target area when displaying the interface shown in FIG. 2. The brightness inside the target area is adjusted to be slightly higher than the brightness of area surrounding the target area, making the target area stand out.

A benefit of determining whether to adjust illumination information in the target area according to the third condition is that it ensures that a target position appears between two adjacent three-dimensional object display areas, which occurs as a user operates, causing the target position moves from one of the three-dimensional object display areas to another three-dimensional object display area, for example, moving from area 201 to area 202 as shown in FIG. 2. Determining whether to adjust the illumination information according to the third condition can ensure that in the above scenario, a content displayed in the target area is similar during an entire movement process, thereby avoiding a sudden appearance and rapid disappearance of the cursor during the movement process and causing visual frustration to the user, and improving the visual effect of glasses-free three-dimensional screen when the three-dimensional objects are displayed according to the method described in the embodiment.

Optionally, when the third condition is applied, a movement trajectory of the target position over the past period can be additionally considered to determine whether to adjust the illumination information. For example, when the target position is between adjacent three-dimensional object display areas, a movement trajectory of the target position can be detected within a previous preset duration such as a past five seconds. If a movement trajectory passes through any one of the two adjacent three-dimensional object display areas, the illumination information is adjusted in the target area. If the movement trajectory does not pass through any one of the two adjacent three-dimensional object display areas, the illumination information is not adjusted, and the cursor is displayed in the target area instead.

In one embodiment, the adjustment of the illumination information in the target area can be realized by adjusting a light source acting on the three-dimensional object display areas. To present a three-dimensional visual effect on a flat display screen, the electronic device needs to render a corresponding three-dimensional model according to the light source. In the electronic device, a light source is usually represented by a set of parameters that defines various properties thereof, which include but are not limited to intensity, type, beam angle, color, relative positional relationship between the light source and the three-dimensional objects, and the like.

A method to adjust the illumination information in the target area can include adding a mouse light source, which would affect the target area by incorporating a set of parameters representing the light source and adjusting values of one or more parameters of the mouse light source as necessary. The brightness information in the target area affected by the mouse light source, the contrasts and shadow clarities of the three-dimensional objects and the like change simultaneously in response to the addition of light sources and adjustments in light source parameters. For example, the brightness in the target area increases as the intensity of the mouse light source increases. After relative positions of the mouse light source and the three-dimensional objects in the target area change, some originally blurry shadows may become clearer, and clear shadows may become blurry. The setting and adjustment of various parameters in the mouse light source can be determined according to actual conditions, which are not limited herein.

In S103, the specific illumination information to be adjusted in the target area can be determined according to the content displayed in the target area. The specific implementation of S103 is described below with reference to the embodiments.

When planes with only a single orientation on three-dimensional objects are displayed in the target area, a first implementation of S103 may be to increase the brightness in the target area to a first brightness according to the three-dimensional object display areas and position information. The first brightness is higher than a second brightness in a non-target area.

FIG. 3 illustrates a schematic diagram for displaying three-dimensional objects according to adjusted illumination information consistent with various embodiments of the present disclosure. In one embodiment, FIGS. 3(a) and (b) respectively show how three-dimensional objects are displayed at different target positions. The three-dimensional objects shown in FIG. 3(a) and FIG. 3(b) are same and consist of a three-dimensional object 301 (backplate), a three-dimensional object 302 (player), and a three-dimensional object 303 (text). Area 304 shown in FIG. 3(a) represents a target area centered on a target position.

As can be seen from FIG. 3(a), in one embodiment, only one plane of the backplane is displayed in the target area. There is no way to distinguish between the light-receiving surface and the backlight surface within the target area, so there is no need to adjust shadow clarity and contrast of three-dimensional objects. Therefore, to adjust the illumination information in the target area, only the brightness in the target area needs to be increased to the first brightness according to an intensity of the additional light source. To visually display a duration for which the target position remains within the three-dimensional object display areas, the target area can be continuously adjusted as follows.

In one implementation, the first brightness is increased with an extension of a duration, which refers to a period during which the position corresponding to the position information remains within the three-dimensional object display areas. That is, as the target position remains in the three-dimensional object display areas for a longer time, the brightness of area 304 in FIG. 3(a) gradually increases. An upper limit of brightness can be set, and when the first brightness is increased to the upper limit of brightness, the first brightness will no longer be increased.

In another implementation, a range of the target area increases with the extension of the duration, which refers to a duration that the position corresponding to the position information remains in the three-dimensional object display areas. That is, as the target position remains in the three-dimensional object display areas for a longer time, a coverage range of area 304 in FIG. 3(a) gradually increases. An upper limit of the range of the target area can be set, and when the target area reaches the upper limit of the range, the target area ceases expanding.

When a plurality of surfaces of the three-dimensional objects with different orientations are displayed in the target area, a second implementation of S103 may be: improving the brightness of the light-receiving surfaces of the three-dimensional objects and the shadow clarity of the backlight surfaces of the three-dimensional objects in the target area according to the three-dimensional object display areas and position information (former method, or improving the brightness of the light-receiving surfaces of the three-dimensional objects, the contrast of the three-dimensional objects, and the shadow clarity of the backlight surface of the three-dimensional objects in the target area according to the three-dimensional object display areas and position information (latter method).

Optionally, when a complete three-dimensional model is not displayed in the target area, the illumination information can be adjusted in the target area according to the former method described above. When the complete three-dimensional model is displayed in the target area, the illumination information can be adjusted in the target area according to the latter method described above.

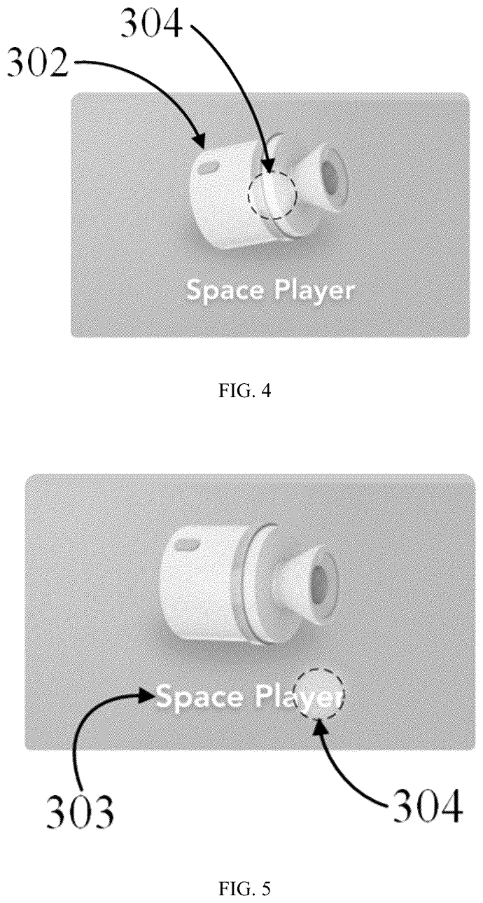

FIG. 4 illustrates another schematic diagram for displaying a three-dimensional object according to adjusted illumination information consistent with various embodiments of the present disclosure. In one embodiment, as shown in FIG. 4, there are a plurality of surfaces with different orientations of the three-dimensional object 302 displayed in the target area. Due to an effect of the mouse light source acting on the target area, some surfaces face towards the mouse light source (i.e., light-receiving surfaces), while some surfaces face away from the mouse light source (i.e., backlight surfaces).

According to the additional mouse light source and the three-dimensional structure displayed in the target area, on the one hand, a brightness of the light-receiving surfaces can be increased to surpass a brightness of the light-receiving surfaces outside the target area, on the other hand, a shadow clarity of the backlight surfaces can be improved in the target area to surpass a shadow clarity of the backlight surfaces outside the target area. Therefore, the target area appears to be illuminated by the new mouse light source.

FIG. 5 illustrates another schematic diagram for displaying three-dimensional objects according to adjusted illumination information consistent with various embodiments of the present disclosure. In one embodiment, a text three-dimensional object consists of a plurality of letter three-dimensional models. As shown in FIG. 5, a plurality of surfaces with different orientations of the three-dimensional object are displayed in the target area, and a complete three-dimensional model, especially the letter “e”, is displayed. The brightness of the light-receiving surfaces and the shadow clarity of the backlight surfaces can be adjusted in the target area according to the implementation shown in FIG. 4. A contrast of the three-dimensional model illuminated by the additional mouse light source in the target area can be further adjusted, so that the illuminated three-dimensional model has a higher contrast than the three-dimensional model not illuminated by the additional mouse light source.

It can be understood that in the second implementation of S103, information such as the brightness of the light-receiving surfaces, the shadow clarity of the backlight surfaces, and the contrast of the three-dimensional objects can also be adjusted with an extension of a duration.

As described above, adjusting the illumination information in the target area can be realized by adding a mouse light source that acts on the target area and adjusting corresponding parameters. Therefore, in the second implementation of S103, parameters of the mouse light source acting on the target area can be gradually adjusted as the duration extends. For example, as the duration extends, the intensity of the mouse light source gradually increases, so that the brightness of the light-receiving surfaces in the target area, the shadows clarity of the backlight surfaces, and the contrast of three-dimensional objects gradually increase with the duration.

Similarly, in the second implementation of S103, the range of the target area can also gradually increase with the extension of the duration.

S104: displaying a three-dimensional object in the three-dimensional object display areas according to the adjusted illumination information.

The three-dimensional object refers to a three-dimensional object displayed in the three-dimensional object display areas including the target position. Referring to FIGS. 3-5, when the target position is as shown in FIG. 3(a) or FIG. 3(b), while the display area of the three-dimensional objects 302 and 303 does not include the target position, and the display area of the three-dimensional object 301 includes the target position. Therefore, in S104, the three-dimensional object refers to the three-dimensional object 301, i.e., the backplate.

When the target position is as shown in FIG. 4, the display area of the three-dimensional object 302 includes the target position. Therefore, in S104, the three-dimensional object refers to the three-dimensional object 302, i.e., the player. When the target position is as shown in FIG. 5, the display area of the three-dimensional object 303 includes the target position. Therefore, in S104, the three-dimensional object refers to the three-dimensional object 303, i.e., the text.

During a display of the three-dimensional objects according to the adjusted illumination information, the three-dimensional object can remain stationary or move according to certain rules. For the latter, a first movement method of the three-dimensional object can be that when the target position remains within the three-dimensional object display areas, the three-dimensional object continues to move until the target position moves out of the three-dimensional object display areas. A second movement method can be that when the target position moves into the three-dimensional object display areas, the three-dimensional object moves from an initial pose to a specific target pose and remains stationary in the target pose. When the target position moves out of the three-dimensional object display areas, the three-dimensional object returns to the initial pose.

Pose is a general term for a position and attitude of a three-dimensional object. The position can be represented by coordinates of the three-dimensional object in a spatial coordinate system. The attitude can be represented by angles of the three-dimensional object in different directions, such as tilt angle, rotation angle and pitch angle. The initial pose refers to a pose of the three-dimensional object when the target position has not moved to a three-dimensional object display area.

If the three-dimensional object is displayed according to the first movement method, S104 may include displaying a motion animation of the three-dimensional object in the three-dimensional object display areas according to the adjusted illumination information. Different three-dimensional objects can have different forms of motion animation. For example, when the target position is as shown in FIG. 3(a) or FIG. 3(b), the motion animation of the three-dimensional object 301 may include a sequence of rotations: counterclockwise rotation at a certain angle around an axis passing through a center of the backplate and perpendicular to the screen, followed by clockwise rotation at a certain angle, and another counterclockwise rotation at a certain angle. The above sequence of rotations is repeated.

When the target position is as shown in FIG. 4, the motion animation of the three-dimensional object 302 can include translating a certain distance to the left in the horizontal direction, translating a certain distance to the right, translating a certain distance to the left, and repeating the above translations.

When the target position is as shown in FIG. 5, the motion animation of the three-dimensional object 303 can include a sequence of rotations: counterclockwise rotation at a certain angle around the axis passing through the center of the text and perpendicular to the screen, clockwise rotation at a certain angle, and another counterclockwise rotation at a certain angle. The above sequence of rotations is repeated.

Optionally, a same three-dimensional object can also correspond to a plurality of different motion animations. A specific motion animation to be displayed can be determined according to the operation instructions acquired by the mouse when the position information is acquired.

For example, when the target position is as shown in FIG. 4, the motion animation of the three-dimensional object 302 can be displayed. If an operation command acquired by the mouse while acquiring the position information is to press and hold the right button of the mouse, the motion animation of the three-dimensional object 302 can be displayed in the above-described method. If the operation instruction acquired by the mouse while acquiring the position information is to press and hold the left mouse button, the motion animation of the three-dimensional object 302 can include continuous counterclockwise or clockwise rotation around an axis passing through its center and perpendicular to the screen. Optionally, in motion animation, the motion amplitude of the three-dimensional object is determined by the duration.

An approach to determining the motion amplitude according to duration is to increase the motion amplitude with duration until reaching an upper limit. Another approach to determining the motion amplitude according to duration is to allow the motion amplitude to fluctuate within a certain range as the duration increases.

In one embodiment, the motion amplitude can be any parameter related to a motion state of the three-dimensional object in any of the above motion animations. For example, the motion amplitude can refer to a rotation speed and angle when the three-dimensional object rotates around a specific axis, the moving speed and distance when the three-dimensional object is translated in a specific direction.

If the three-dimensional object is displayed according to the second movement method, S104 may include: adjusting a pose information of the three-dimensional object according to the display area and position information of the three-dimensional object; and displaying the three-dimensional object in the three-dimensional object display areas according to the adjusted illumination information and the pose information.

For different three-dimensional objects, the pose information can be adjusted in different ways. For example, when the target position is as shown in FIG. 3(a) or FIG. 3(b), an adjustment method for the pose information of the three-dimensional object 301 may be that the backplate tilts forward along a z-axis at the target position. For example, when the target position is as shown in FIG. 3(a), an upper left corner of the backplate moves forward along the z-axis, causing the back plate to tilt forward at the upper left corner, when the target position is as shown in FIG. 3(b), an upper right corner of the backplate moves forward along the z-axis, causing the backplate to tilt forward at the upper right corner. The z-axis refers to an axis perpendicular to the screen.

When the target position is as shown in FIG. 4, the adjustment method for the pose information of the three-dimensional object 302 may include rotating the motion animation of the three-dimensional object 302 counterclockwise at a certain angle around an axis passing through the center of the text and perpendicular to the screen. When the target position is as shown in FIG. 5, the adjustment method for the pose information of the three-dimensional object 303 may include moving the three-dimensional object 303 forward a certain distance along the z-axis.

In some optional embodiments, the electronic device can associate the range of the target area with a z-axis coordinate of the three-dimensional object. When a position of the three-dimensional object is relatively forward and the coordinate value of the z-axis is large, the target area can have a larger range. When the position of the three-dimensional object is relatively far back and the coordinate value of the z-axis is small, the target area can have a smaller range.

Further, as the three-dimensional object moves along the z-axis, the range of the target area can gradually change according to the above rules. In the embodiment described above, when the upper right corner of the back panel moves forward along the z-axis, the range of the target area in the upper right corner of the back panel can gradually increase. Conversely, when the three-dimensional object moves backward along the z-axis, the range of the target area on the three-dimensional object can gradually decrease.

The purpose of adjusting the range of the target area in the aforementioned manner is that: on the one hand, users can intuitively see the distance of different three-dimensional objects through target areas of different sizes; on the other hand, gradually adjusting the range of the target area during the movement of the three-dimensional object along the z-axis can ensure smoother changes of the target area in size and avoid abrupt changes of the target area in size when the three-dimensional object moves and transitions between different three-dimensional objects, thereby improving a visual effect.

In one embodiment, during a process of adjusting the pose information of the three-dimensional object, a movement of the three-dimensional object may be displayed or may not be displayed in the three-dimensional object in a form of animation.

It should be noted that when the three-dimensional object in the three-dimensional object display areas is moved in any of the above methods, a shadow in a three-dimensional object display area can be adjusted simultaneously, including but not limited to adjusting the clarity, position, and area of the shadow.

The present solution changes the illumination information of the target area when the three-dimensional object is displayed to realize a visual effect of the target area where the position information is highlighted on the glasses-free three-dimensional screen. The present solution does not incorporate three-dimensional model data representing the cursor into the three-dimensional object display areas, thereby eliminating the cross-mode phenomenon between the cursor and the three-dimensional object. Therefore, the present solution can not only avoid the cross-mode phenomenon, but also highlight a position indicated by the position information in the display system.

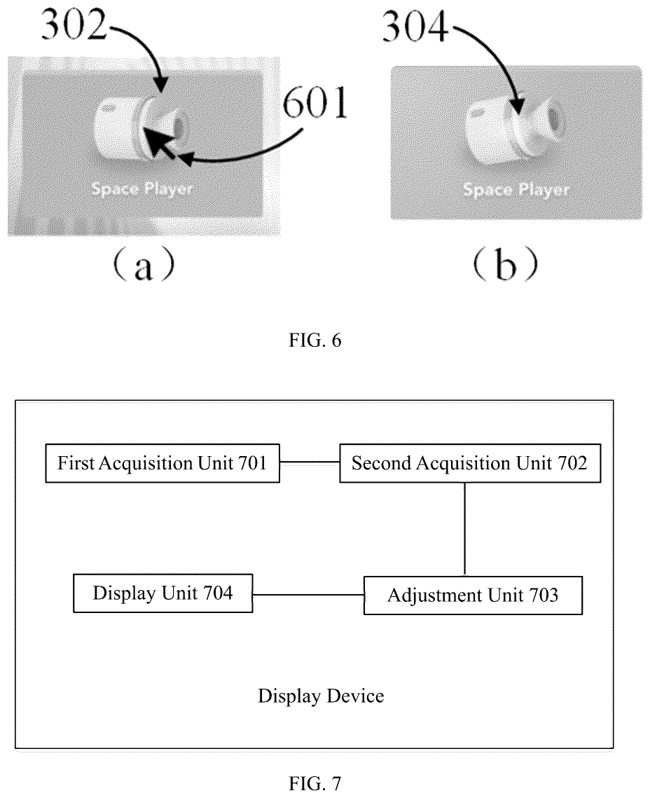

To facilitate understanding of beneficial effects of the embodiments, the following uses FIG. 6 as an example to illustrate differences between displaying a cursor according to a method of a related art and displaying a three-dimensional object according to the method of the embodiments of the present disclosure.

FIG. 6 illustrates a comparison diagram of directly displaying a cursor and adjusting illumination information consistent with various embodiments of the present disclosure. FIG. 6(a) illustrates a schematic diagram of a scene where the cursor is directly displayed, in which 601 represents the cursor displayed in a three-dimensional object display area. The three-dimensional object 302 cannot be completely displayed to the user due to an obstruction of the cursor model. FIG. 6(b) illustrates a schematic diagram when the three-dimensional object is displayed according to the method of the present disclosure. As can be seen from FIG. 3(a) and FIG. 3(b), on the one hand, adjusting the illumination information in the target area may not affect a complete display of the three-dimensional object 302. A complete structure of the three-dimensional object 302 can still be seen from FIG. 6(b). On the other hand, by adjusting the illumination information in the target area, a visual effect of being illuminated by the mouse light source can be presented in the target area 304, thereby visually distinguishing the target area from surrounding areas not illuminated by the mouse light source, so as to highlight the target area where the target position is on the glasses-free three-dimensional screen to aid users in human-computer interaction.

FIG. 7 illustrates a schematic diagram of a display device consistent with various embodiments of the present disclosure. The device may include a first acquisition unit 701 for acquiring position information of mouse; a second acquisition unit 702 for acquiring three-dimensional object display areas of a glasses-free three-dimensional screen; an adjustment unit 703 for adjusting illumination information in a target area according to the three-dimensional object display areas and position information, the target area being a preset range area centered on a position corresponding to the position information, and the illumination information includes at least one of brightness information, contrast and shadow clarity of three-dimensional objects; and a display unit 704 for displaying the three-dimensional objects in the three-dimensional object display areas according to the adjusted illumination information.

Optionally, when the illumination information is adjusted in the target area according to the three-dimensional object display areas and position information, the adjustment unit 703 is specifically configured to increase the brightness in the target area to a first brightness according to the three-dimensional object display areas and position information. The first brightness is higher than a second brightness in a non-target area.

Optionally, the adjustment unit 703 is also configured to increase the first brightness as a duration extends. The duration refers to a period during which a position corresponding to the position information remains within the three-dimensional object display areas. Optionally, the adjustment unit 703 is also configured to increase a range of the target area as a duration extends. The duration refers to a period during which a position corresponding to the position information remains within three-dimensional object display areas.

Optionally, when the adjustment unit 703 adjusts the illumination information in the target area according to the three-dimensional object display areas and position information, the adjustment unit 703 is specifically configured to improve a brightness of the light-receiving surfaces of the three-dimensional object, a contrast of the three-dimensional object, and a shadow clarity of the backlight surfaces of the three-dimensional object in the target area according to the three-dimensional object display areas and position information.

Optionally, when the adjustment unit 703 adjusts the illumination information in the target area according to the three-dimensional object display areas and position information, the adjustment unit 703 is specifically configured to adjust the illumination information in the target area when the corresponding position of the position information remains within the three-dimensional object display areas, or between adjacent three-dimensional object display areas. The adjacent three-dimensional object displays areas refer to two three-dimensional object display areas whose distance is not greater than a distance threshold.

Optionally, when the display unit 704 displays the three-dimensional object in the three-dimensional object display areas according to the adjusted illumination information, the display unit 704 is specifically configured to display a motion animation of the three-dimensional object in the three-dimensional object display areas according to the adjusted illumination information.

Optionally, in the motion animation, a motion amplitude of the three-dimensional object is determined by the duration, which refers to a period that a position corresponding to the position information remains within the three-dimensional object display areas.

Optionally, when the display unit 704 displays the three-dimensional object in the three-dimensional object display areas according to the adjusted illumination information, the display unit 704 is specifically configured to adjust the pose information of the three-dimensional object according to the three-dimensional object display areas and position information and display the three-dimensional object in the three-dimensional object display areas according to the adjusted illumination information and pose information.

A specific working principle of the display device in the present disclosure can be referenced from relevant steps outlined in the display method described in any embodiment of the present specification, which are not reiterated herein.

It should be noted that each embodiment in the present specification is described in a progressive manner. Each embodiment focuses on differences from other embodiments. Same and similar parts between various embodiments are referred to each other.

For a convenience of description, when the above system or device is described, functions are divided into various modules or units and described separately. When implementing the present disclosure, functions of each unit can be implemented using the same or a variety of software and/or hardware.

From the above description of the embodiments, a person skilled in the art can clearly understand that the present disclosure can be implemented using software along with a necessary general hardware platform. Therefore, the essence of the technical solution or part of the technical solution that contributes to the existing technology can be embodied in a form of a software product such as an optical disk, or the like. It should also be noted that in the present specification, relational terms such as ‘first,’ ‘second,’ ‘third,’ ‘fourth,’ and similar expressions are solely used to distinguish between different entities or operations and do not necessarily imply any inherent relationship or sequence among the entities or operations. Furthermore, the terms “comprises,” “includes,” or any other variation thereof are intended to cover a non-exclusive inclusion such that a process, method, article, or apparatus containing a list of elements includes not only those explicitly mentioned, but also other elements not expressly listed or inherent to the process, method, article, or apparatus. Without further limitation, an element defined by the statement “includes a . . . ” does not exclude the presence of additional identical elements in a process, method, article, or apparatus that includes the stated element.

As disclosed, the display method and display device provided by the present disclosure at least realize the following beneficial effects.

The present solution changes illumination information of a target area when a three-dimensional object is displayed to realize a visual effect of the target area where position information is highlighted on a glasses-free three-dimensional screen. The present solution does not add three-dimensional model data representing a cursor in a three-dimensional object display area, thereby preventing a cross-mode phenomenon between the cursor and the three-dimensional object. Therefore, the present solution can not only avoid the cross-mode phenomenon, but also highlight a position indicated by the position information in a display system.

The above are only preferred embodiments of the present disclosure. It should be noted that a person skilled in the art can also make several improvements and modifications without departing from principles of the present disclosure. The improvements and modifications are also should be considered within the protection scope of the present disclosure.

What is claimed is:

1. A display method, comprising:
acquiring position information of a mouse;
acquiring three-dimensional object display areas of a glasses-free three-dimensional screen;
adjusting illumination information within a target area according to the three-dimensional object display areas and the position information, the target area being a preset range area centered on a position corresponding to the position information, and the illumination information including at least one of brightness information, contrast, and shadow sharpness of a three-dimensional object; and
displaying the three-dimensional object in the three-dimensional object display areas according to the adjusted illumination information.

2. The method according to claim 1, wherein adjusting the illumination information within the target area according to the three-dimensional object display areas and the position information includes:
increasing a brightness in the target area to a first brightness higher than a second brightness in a non-target area according to the three-dimensional object display areas and the position information.

3. The method according to claim 2, further comprising:
increasing the first brightness as a duration extends, the duration referring to a period during which a position corresponding to the position information remains within the three-dimensional object display areas.

4. The method according to claim 2, further comprising:
increasing a range of the target area as a duration extends, the duration referring to a period during which a position corresponding to the position information is in the three-dimensional object display areas.

5. The method according to claim 2, wherein the adjusting illumination information within a target area according to the three-dimensional object display areas and the position information includes:
improving a brightness of light-receiving surfaces of the three-dimensional object, a contrast of the three-dimensional object, and a shadow clarity of the backlight surfaces of the three-dimensional object in the target area according to the three-dimensional object display areas and the position information.

6. The method according to claim 1, wherein adjusting illumination information within the target area according to the three-dimensional object display areas and the position information includes:
adjusting the illumination information within the target area when a position corresponding to the position information is within the three-dimensional object display areas or between adjacent three-dimensional object display areas, the adjacent three-dimensional object display areas referring to two three-dimensional object display areas whose distance is not greater than a distance threshold.

7. The method according to claim 1, wherein displaying the three-dimensional object in the three-dimensional object display areas according to the adjusted illumination information includes:
displaying a motion animation of the three-dimensional object in the three-dimensional object display areas according to the adjusted illumination information.

8. The method according to claim 7, wherein a motion amplitude of the three-dimensional object is determined according to a duration, which refers to a period during which a position corresponding to the position information remain within the three-dimensional object display areas.

9. The method according to claim 1, wherein displaying the three-dimensional object in the three-dimensional object display areas according to the adjusted illumination information includes:
adjusting pose information of the three-dimensional object according to the three-dimensional object display areas and the position information; and
displaying the three-dimensional object in the three-dimensional object display areas according to the adjusted illumination information and the pose information.

10. The method according to claim 1, wherein acquiring the three-dimensional object display areas includes: reading, a processor, image data currently displayed on the glasses-free three-dimensional screen, identifying an area where the three-dimensional model is located in the image data, and identifying the three-dimensional object on the glasses-free three-dimensional screen according to the area where the three-dimensional model is located and a mapping relationship between the image data and the glasses-free three-dimensional screen.

11. A display device, comprising:
one or more processors configured to perform:
acquiring position information of a mouse;
acquiring three-dimensional object display areas of a glasses-free three-dimensional screen; and
adjusting illumination information within a target area according to the three-dimensional object display areas and the position information, the target area being a preset range area centered on a position corresponding to the position information, and the illumination information including at least one of brightness information, contrast, and shadow sharpness of a three-dimensional object, and
a display unit configured for displaying a three-dimensional object in the three-dimensional object display areas according to the adjusted illumination information.

12. The display device according to claim 11, wherein the one or more processors are further configured to perform:
increasing a brightness in the target area to a first brightness higher than a second brightness in a non-target area according to the three-dimensional object display areas and the position information.

13. The display device according to claim 12, wherein the first brightness increases as a duration extends, the duration refers to a period during which a position corresponding to the position information remains within the three-dimensional object display areas.

14. The display device according to claim 12, wherein a range of the target area increases as a duration extends, the duration refers to a period during which a position corresponding to the position information remains within the three-dimensional object display areas.

15. The display device according to claim 12, wherein the one or more processors are further configured to perform:
improving a brightness of light-receiving surfaces of the three-dimensional object, a contrast of the three-dimensional object, and a shadow clarity of the backlight surfaces of the three-dimensional object in the target area according to the three-dimensional object display areas and the position information.

16. The display device according to claim 11, wherein the one or more processors are further configured to perform:
adjusting the illumination information within the target area when a position corresponding to the position information is within the three-dimensional object display areas or between adjacent three-dimensional object display areas, the adjacent three-dimensional object display areas referring to two three-dimensional object display areas whose distance is not greater than a distance threshold.

17. The display device according to claim 11, wherein the one or more processors are further configured to perform:
displaying a motion animation of the three-dimensional object in the three-dimensional object display areas according to the adjusted illumination information.

18. The display device according to claim 17, wherein a motion amplitude of the three-dimensional object is determined according to a duration, which refers to a period during which a position corresponding to the position information remain within the three-dimensional object display areas.

19. The display device according to claim 11, wherein the one or more processors are further configured to perform:
adjusting pose information of the three-dimensional object according to the three-dimensional object display areas and the position information; and
displaying the three-dimensional object in the three-dimensional object display areas according to the adjusted illumination information and the pose information.

20. The display device according to claim 11, wherein the one or more processors are further configured to perform:
reading image data currently displayed on the glasses-free three-dimensional screen, identifying an area where the three-dimensional model is located in the image data, and identifying the three-dimensional object on the glasses-free three-dimensional screen according to the area where the three-dimensional model is located and a mapping relationship between the image data and the glasses-free three-dimensional screen.
